(19) United States
(12) Patent Application Publication
(10) Pub. No.: US 2026/0298610 A1
(43) Pub. Date: Oct. 1, 2026

(54) Sensor System

(71) Applicant: ADVANTEC INTERNATIONAL LIMITED, Newton Abbot, Devon (GB)

(72) Inventors: Peter FARTHING, Newton Abbot, Devon (GB); Richard Keith John DAY, Martock Somerset (GB)

(21) Appl. No.: 18/998,227

(22) PCT Filed: Jul. 21, 2023
(86) PCT No.: PCT/EP2023/070267

§ 371 Date: Jan. 24, 2025

(30) Foreign Application Priority Data
Jul. 24, 2022 (GB) 2210806.2

(51) Int. Cl. G01B 7/16; G01D 11/30; G01L 1/22; G01L 5/1627; G01P 13/00; G01P 21/00

(52) U.S. Cl. CPC G01B 7/20; G01D 11/30; G01L 1/2206; G01L 5/1627; G01P 13/00; G01P 21/00

(57) ABSTRACT

A sensor assembly (301) for sensing movement of a pile (601) comprises a sensing arrangement (302) comprising at least one sensor (303), a support (304) to carry the sensing arrangement (303), and a controller (306) for controlling the sensing arrangement (302). The support (304) is securable within a hollow (602) of the pile (601) to locate the sensing arrangement (302) within the pile (601) and position the at least one sensor (303) of the sensing arrangement (302) in an operational position with respect to an inner walling (603) of the hollow (602) of the pile (601) for detecting movement of the inner walling (603) of the pile (601). In combination, a pile (601) and the sensor assembly (301). Use of the sensor assembly (301) to detect movement of an inner walling (603) of a hollow (602) of a pile (601).

### FIELD OF THE INVENTION

The present application relates to a sensor system, in particular to a sensor system for use in the rail industry, and more particularly to a sensor system for detecting movements associated with use of a railway track.

### BACKGROUND OF THE INVENTION

For safety reasons, it is important for railways to be properly maintained. Railway tracks are subject to mechanical and thermal stresses, which can lead to defects that if not detected and treated can lead to track breakage and, in turn, derailment of train carriages. It is therefore known for regular track inspection to be performed with the aim of identifying flaws, such as cracks, warping and corrosion, that should be corrected to avoid catastrophic failure and, in turn, accidents. Methods used for assessing the condition of railway tracks include visual inspection and ultrasonic testing. Rail inspection trucks that are equipped with inspection equipment are known.

It is known to use piles to stabilise the ground, for example the track bed or an embankment, or to provide a foundation for a surface structure, for example trackside posts for supporting overhead line equipment. Depending on the specific application, a piling system may utilise sheet piling, for example precast concrete or steel sheet piles, or tubular piling, for example solid or hollow, steel or concrete piles. Installed piles are subject to vibration from use of the railway but are not readily accessible for condition assessment.

The present invention provides a sensor assembly, and a sensor system comprising the sensor assembly, for use with such piles.

### SUMMARY OF THE INVENTION

According to a first aspect there is provided a sensor assembly for sensing movement of a pile, the sensor assembly comprising: a sensing arrangement comprising at least one sensor, and a support to carry the sensing arrangement; the support securable within a hollow of the pile to locate the sensing arrangement within the pile and position the at least one sensor of the sensing arrangement in an operational position with respect to an inner walling of the hollow of the pile for detecting movement of the inner walling of the pile, and a controller for controlling the sensing arrangement.

The support is usable to retain the at least one sensor in operational position with respect to the inner walling of the pile such that the sensor is functional to detect movement of the inner walling of the pile. When in the operational position, the sensor may be in contact with the inner walling of the pile, and able to detect movement of the inner walling of the pile directly. Alternatively, when in the operational position, the sensor may not be in contact with the inner walling of the pile, but able to detect of the inner walling of the pile indirectly via the support. A sensor of the sensing arrangement may be resiliently biased against the inner walling of the hollow of the pile by the support or may be held against a surface of the support that is resiliently biased against the inner walling of the hollow of the pile.

The sensing arrangement may be configured to detect movement of the inner walling of the pile in the form of deformation of the inner walling of the pile, such as when a force is applied to the pile that causes the inner walling of the pile to deform. The sensing arrangement may alternatively or additionally be configured to detect movement of the inner walling of the pile in the form of a change in angular orientation, such as when a force is applied to the pile that causes the inner walling of the pile to move from a reference orientation.

The sensor arrangement may be configured to detect movement of the inner walling of the pile arising from, for example, vibrations caused by rolling stock during typical movements thereof along a track, unexpected impact events, deterioration of the pile due to such factors as time, environmental conditions, wear and tear.

The sensor assembly may comprise at least one further sensing arrangement and respective support, the controller for further controlling the at least one further sensing arrangement. The sensing arrangements may all be alike, or at least one may differ from one or more other of the plurality sensing arrangements; for example, one sensing arrangement may comprise a different number of sensors and/or type of sensor than another of the sensing arrangements controllable by the controller. In an example, the controller is configured for controlling sensing arrangements installed within different piles. In an example, a sensor system comprises a plurality of controllers, each configured for controlling at least one sensing arrangement for detecting movement of a pile.

The sensor assembly may be used to provide information for use in inspections and/or monitoring of pile condition. The sensor assembly may be used in an alert system for providing a warning of a defective pile condition and/or for prompting an unscheduled check of a pile/pile location.

In an example, the at least sensor comprises at least one force sensor for detecting load. In an example, the or each force sensor is a strain gauge. In an example, the force sensor or plurality of force sensors is configured to measure strain in 3 axes.

In an example, the at least sensor comprises at least one gyroscopic sensor for measuring angular deviation from a reference line. In an example, the gyroscopic sensor is a multi-axis gyroscope sensor.

In an example, the support comprises a fixing element attachable to the inner walling of the pile.

In an example, the support comprises an adjustable mounting device configurable between an extended and a retracted condition, in which a span of the adjustable mounting device is greater when in the extended condition than when in the retracted position, the retracted condition for allowing insertion of the support into the hollow of the pile and the extended condition allowing for retaining the support within the pile. In an example, the adjustable mounting device is resiliently biased towards the extended condition.

In an example, the support is configured for resiliently biasing at least one sensor into contact with the inner walling of the pile.

In an example, the support comprises walling, at least a portion of which is a resiliently deflectable portion, in which at least one sensor is held in contact with the walling in a region of a resiliently deflectable portion and the support is configured for resiliently biasing the resiliently deflectable portion into contact with the inner walling of the pile.

In an example, the controller is operatively connected to the sensing arrangement by a communication connection enabling the transfer of data between the controller and the sensing arrangement. In an example, the controller is configured to receive power from a power source and the communication connection enables the transfer of power to the sensing arrangement.

The communication connection between the controller and the sensing arrangement may be a wired connection.

In an example, a communication module enabling wireless communication with a remote device is communicatively connected the controller.

In an example, the sensor assembly further comprises: a further sensing arrangement, comprising at least one sensor, and a further support to carry the further sensing arrangement; the further support securable within the hollow of a pile to locate the further sensing arrangement within the further pile and position the at least one sensor of the further sensing arrangement in an operational position with respect to an inner walling of the hollow of a pile for detecting movement of the inner walling of the pile; the controller further for controlling the further sensing arrangement.

In an example, the controller comprises a compass device and is functional to calibrate the sensor device or sensor devices connected to it in relation to a predetermined direction.

According to a second aspect, a sensor assembly according to the first aspect is used to detect movement of an inner walling of a hollow of a pile.

According to a third aspect there is provided, in combination, a pile and a sensor assembly according to the first aspect.

According to a fourth aspect there is provided sensor package adapted for use in the sensor assembly of the first aspect, the sensor package comprising the sensing arrangement comprising at least one sensor, and the support to carry the sensing arrangement.

According to a fifth aspect there is provided a sensor system comprising a sensor assembly according to the first aspect, in which a communication module enabling wireless communication with a remote device is communicatively connected the controller, and a remote device configured to receive data from the controller, the data derived from operation of the sensor assembly.

According to a sixth aspect there is provided, in combination, a pile and a sensor system according to the fifth aspect.

According to a seventh aspect there is provided a method, comprising the steps of: receiving a sensor assembly according to the first aspect, securing the support of the received sensor assembly within a hollow of a pile to locate the sensing arrangement within the pile and position the at least one sensor of the sensing arrangement in an operational position with respect to an inner walling of the hollow of the pile for detecting movement of the inner walling of the pile, and operating the sensor assembly to detect movement of the pile.

The present invention thus provides a sensor package for use in a sensor assembly for sensing movement of a pile. The sensor package comprises a sensing arrangement comprising at least one sensor, and a support to carry the sensing arrangement. The support is securable within a hollow of a pile to locate the sensing arrangement within the pile and position the at least one sensor of the sensing arrangement in an operational position with respect to an inner walling of the hollow of the pile for detecting movement of the inner walling of the pile. The present invention further provides a sensor assembly comprising the sensor package and a controller for controlling the sensing arrangement of the sensor package. The present invention furthermore provides a sensor system comprising a plurality of the sensor packages and a controller for controlling the sensing arrangements of the sensor packages.

Further particular and preferred aspects of the invention are set out in the accompanying claims.

### BRIEF DESCRIPTION OF THE DRAWINGS

The present invention will now be more particularly described, with reference to the accompanying drawings, in which:

FIG. 1 shows a section through railway track and its foundation, with typical layers present illustrated;

FIG. 2 shows a railway track, with possible positions of piles indicated;

FIG. 3 is a schematic of a sensor system according to an example;

FIG. 4 is a schematic of a sensor system according to another example;

FIG. 5 illustrates possible positions of a sensor package and a controller of the sensor system of FIG. 3;

FIGS. 6 & 7 shows alternative examples of a support of the example sensor system of FIG. 3, in a secured condition within a hollow of a pile;

FIG. 8 shows schematically a side cross-sectional view of an example sensor package of the example sensor system of FIG. 3;

FIG. 9 shows schematically computing hardware of an example controller of the example sensor system of FIG. 3;

FIG. 10 illustrates features of an example sensor assembly network; and

FIG. 11 & 12 shows features of an example sensor package.

### DESCRIPTION

Illustrative embodiments and examples are described below in sufficient detail to enable those of ordinary skill in the art to embody and implement the apparatus described herein. It is to be understood that embodiments and examples can be provided in many alternate forms and the invention should not be construed as limited to the embodiments and examples set forth herein but by the scope of the appended claims.

Unless otherwise defined, all terms (including technical and scientific terms) used herein are to be interpreted as is customary in the art. In addition, features referred to herein in the singular can number one or more, unless the context clearly indicates otherwise. Similarly, the terms “comprises”, “comprising”, “includes”, “including”, “has” and/or “having” when used herein, specify the presence of the stated feature or features and do not preclude the presence or addition of one or more other features, unless the context clearly indicates otherwise. In the following description, all orientational terms, such as upper, lower, radially and axially, are used in relation to the drawings and should not be interpreted as limiting on the invention, unless the context clearly indicates otherwise. The drawings are not necessarily drawn to scale, and in some instances the drawings may have been exaggerated or simplified for illustrative purposes only.

A sensor system comprising a sensor assembly is provided. The sensor assembly is usable in a pile, for sensing movement of the pile. For example, the sensor assembly is usable to detect deformation of a pile in the vicinity of a railway track and subject to vibration from use of the railway. The sensor assembly comprises a sensor package, which comprises a sensing arrangement comprising at least one sensor, and a support to carry the sensing arrangement. The support is securable within a hollow of a pile to locate the sensing arrangement within the pile and position the at least one sensor of the sensing arrangement in an operational position with respect to an inner walling of the hollow of the pile for detecting movement of the inner walling of the pile. The sensor assembly comprises a controller for controlling the sensing arrangement.

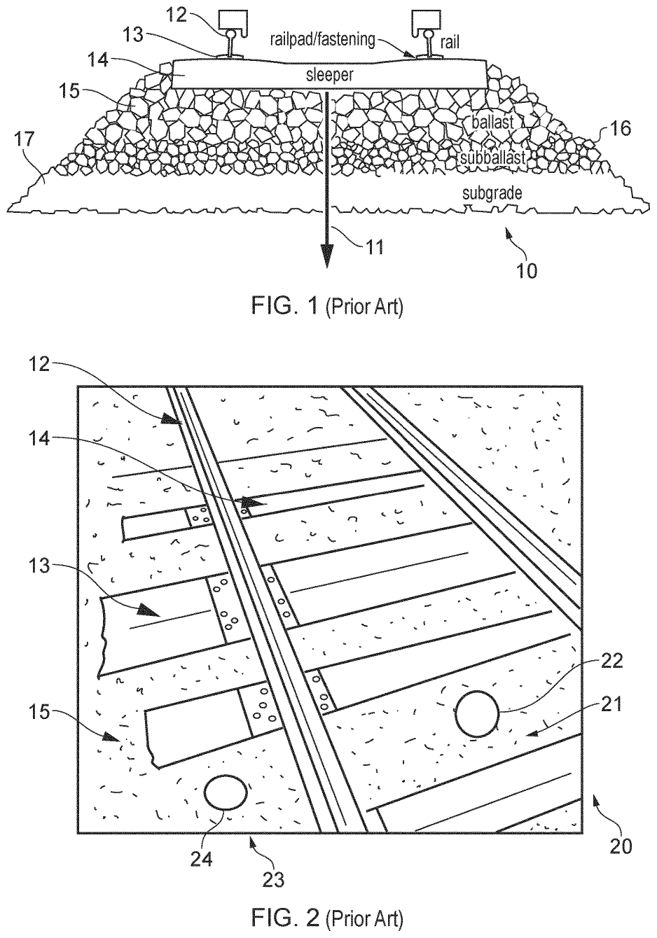

FIG. 1 shows a section 10 through railway track and its foundation, with typical layers present illustrated. The following are indicated, ordered in the direction of arrow II that points from the surface deeper into the ground, rail 12, railpad/fastening 13, sleeper 14, ballast 15, subballast 16 and subgrade 17.

It is known for piles to be driven into the harder subgrade material to support track stability. Such piles generally have the form of a hollow tube and vary in length and diameter. A pile depth of up to 8 m is common. There may be up to 3 piles per sleeper section.

FIG. 2 shows a section of railway track 20 and indicates possible positions of piles, for example position 21 of pile 22, which is between the rails 12 and between sleepers 14, and position 23 of pile 24, which is outside of the rails 12 and between sleepers 14.

An example of a sensor assembly and sensor system comprising the sensor assembly will now be described.

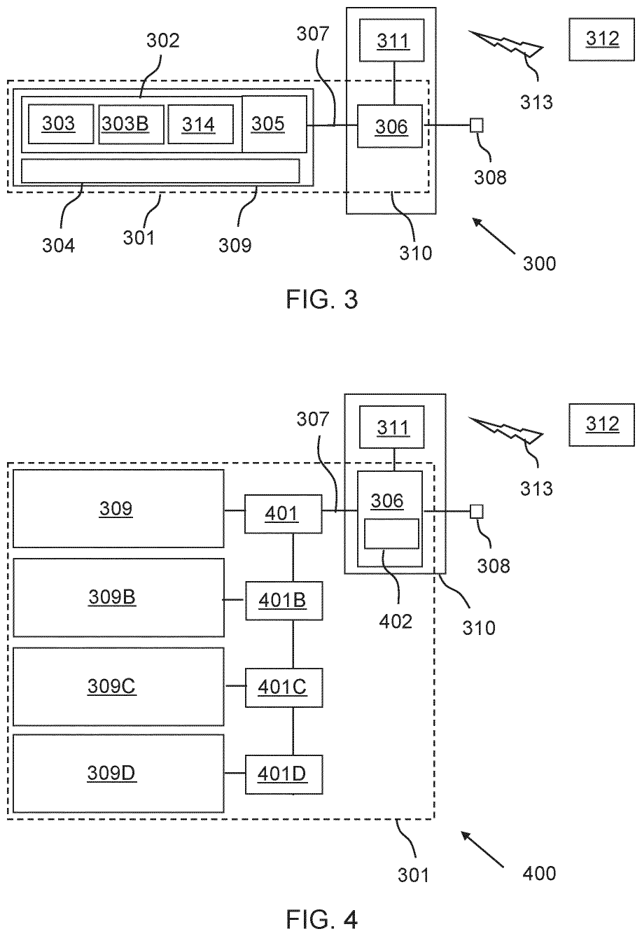

A schematic of an example sensor system 300 is shown in FIG. 3. Sensor system 300 comprises a sensor assembly 301, for sensing movement of a pile (not shown in this Figure). The sensor assembly 301 comprises a sensing arrangement 302, which comprises at least one sensor 303 and a support 304 to carry the sensing arrangement 302.

The sensing arrangement 302 may comprise at least one force sensor for measuring load on the pile and/or at least one gyroscopic sensor for measuring angular deviation from a reference line.

According to the present illustrated example of sensing arrangement 302, the at least one sensor comprises at least one force sensor 303, 303B, for sensing a load on a pile.

The support 304 is securable within a hollow of the pile to locate the sensing arrangement 302 within the pile and position the at least one force sensor 303, 303B of the sensing arrangement 302 relative to an inner walling of the hollow of the pile for detecting a mechanical force applied on the inner walling of the pile.

Preferably, the sensing arrangement comprises or is operatively associated with signal conditioning electronics for processing outputs from the or each sensor 303, 303B. In this specific example, sensing arrangement 302 comprises a signal conditioning module 305.

The sensor assembly 301 further comprises a controller 306, for controlling the sensing arrangement 302.

According to this specific example, the controller 306 is operatively connected to the sensing arrangement 302 by a communication connection 307 that enables the transfer of data between the controller 306 and the sensing arrangement 302. According to this specific example, the communication connection 307 between the controller 306 and the sensing arrangement 302 is a wired connection.

The signal conditioning electronics 305 processes outputs from the at least one sensor 303 of the sensing arrangement 302 for supplying to the controller 306.

According to this specific example, the controller 306 is configured to receive power from a power source 308 and the communication connection 307 enables the transfer of power to the sensing arrangement 303. The power source 308 may be mains power or a battery resource, which may receive power from any suitable source or sources, for example a solar array and/or mains power, or a capacitor bank.

According to this specific example, the sensing arrangement 302 and the support 304 are comprised by a sensor package 309, for securing to the pile (not shown in this Figure), and the controller 306 is comprised by a telemetry station 310, for positioning at an appropriate site. In addition, in this specific example, a communication module 311 enabling wireless communication with a remote device 312, as indicated at 313, is communicatively connected to the controller 306. According to this specific example, the communication module 311 is also comprised by the telemetry station 310.

The remote device 312 may be a remote computer, which may be a desktop computer. The remote device 312 may be in communication with the telemetry station 310 via a wireless telecommunication network operating in accordance with any suitable communications protocol.

Wireless communication may be, for example, via Wifi, Bluetooth, GSM (global system for mobile communications), or GPRS (General Packet Radio Service).

The sensor system 300 may comprise the telemetry station 310 and may further comprise the remote device 312. The telemetry station 310 may comprise a housing made using any suitable material or materials and any suitable manner of construction. Preferably, the housing is designed to be robust and withstand use outdoors in all weather.

In a specific example, the or each force sensor 303, 303B is a strain gauge. A strain gauge may desirably be relatively mechanically robust and resistant to mechanical damage. In an example, the or each force sensor 303, 303B is a strain gauge comprising a convoluted electrically conductive trace. In an example, the force sensor or plurality of force sensors 303, 303B is configured to measure strain in 3 axes.

In addition to the at least one force sensor 303, 303B, the sensing arrangement 302 may comprise one or more sensors of another type and may further comprise one or more sensors of at least one other type.

According to the present illustrated example of sensing arrangement 302, the sensing arrangement 302 further comprises a gyroscopic sensor 314 for measuring angular deviation from a reference line. In an example, the gyroscopic sensor may be a multi-axis gyroscope sensor, for example a 6-axis gyroscope sensor.

A sensor system may comprise a sensor assembly that comprises a controller and a plurality of sensor packages.

A schematic of an example sensor system 400 is shown in FIG. 4. Sensor system 400 differs from the sensor system 300 of FIG. 3 in that the controller 306 is operatively connected to each of a plurality of sensor packages, with sensor packages 309-309D being illustrated.

In this specific illustrated example, each sensor package 309-309D of sensor system 400 comprises a sensing arrangement and a support, similar to sensor package 309 of sensor system 300 comprising sensing arrangement 302 and support 304.

It is to be appreciated however that in a sensor system comprising a plurality of sensor packages, such as in the example sensor system 400 of FIG. 4, the sensing arrangements and supports of those sensor packages may differ from those of the specific example of a sensor package 309 described above in relation to the example sensor system 300 illustrated in FIG. 3. While the sensing arrangement of each of the plurality of sensor packages may also comprise at least one force sensor and/or at least one gyroscopic sensor, the sensing arrangements of the plurality of sensor packages may be all the same or the sensing arrangement of one or more of the sensor packages may differ from one or more other of the sensor packages.

The plurality of sensor packages 309-309D are monitored by the one controller 306 via a single, wired communication connection 307 to which each sensor package 309-309D is connected via an individual terminal block 401-40ID. Each terminal block comprises serial data control electronics compatible with a data bus communication system, and permits the aggregation of data on a single line to reduce cabling to the controller.

In at least this present example, the controller 306 is associated with a compass device 402 and is functional to calibrate the sensor device or sensor devices connected to it in relation to a predetermined direction, for example in relation to a specified heading or railway track direction. The compass device 402 may be any type suitable to achieve the desired functionality,

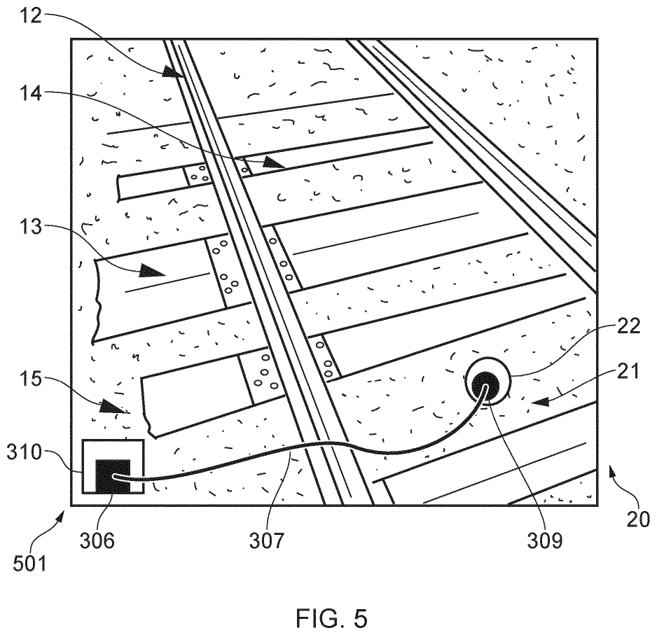

FIG. 5 illustrates possible positions of components of the sensor assembly 301 of the example sensor system 300 of FIG. 3. FIG. 5 shows the section of railway track 20 shown in FIG. 2, with sensor package 309 illustrated as being secured within pile 22 at position 21, between the rails 12, and with controller 306 illustrated as being comprised by telemetry station 310 at a position 501, outside of the rails 12.

The support 304 of sensor assembly 301 may have any suitable form, and may be retained within a pile in any suitable way, which may utilise welding, adhesion/bonding, or a mechanical arrangement.

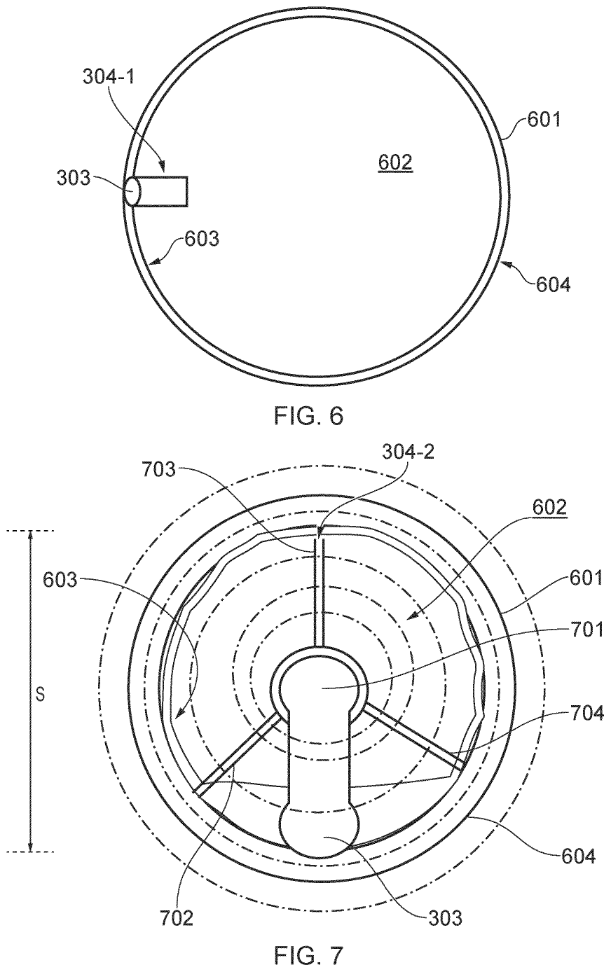

Specific, non-limiting examples of the support 304 of sensor assembly 301 will now be described with reference to FIGS. 6 & 7, each of which show a pile 601 having a hollow 602 with inner walling 603. Outer walling 604 of the pile 601 is also indicated in these Figures.

A support 304-1 is shown in FIG. 6, the support 304-1 comprising a fixing element that is attachable to the inner walling 603 of the pile 601. Preferably, the fixing element is securable within the hollow of the pile in a way that does not damage or interfere with the existing condition of the pile.

A support 304-2 is shown in FIG. 7, the support 304-2 comprising an adjustable mounting device that is configurable between an extended condition (shown in this Figure) and a retracted condition, in which a span S of the adjustable mounting device is greater when in the extended condition than when in the retracted position, the retracted condition for allowing insertion of the support 304-2 into the hollow 602 of the pile 601 and the extended condition allowing for retaining the support 304-2 within the pile 601.

According to this specific illustrated example, the adjustable mounting device of the support 304-2 comprises a central hub 701 to which a plurality of spokes, such as spokes 702, 703, 704, are pivotally connected to be movable towards and away from a central axis extending through the hub 701. Although 3 spokes are shown, it is to be appreciated that a different of spokes could be utilised.

In an example, the adjustable mounting device is resiliently biased towards the extended condition.

Thus, a compressive force can be applied to the adjustable mounting device to move it into, and hold it in, the retracted condition, the adjustable mounting device can then be located in the hollow of the pile and thereafter the applied compressive force removed to allow the adjustable mounting device to move back into the extended condition. The support may utilise one or more biasing elements, for example springs, in achieving the resilient biasing functionality. Resilient biasing may be utilised to secure the support within the hollow of the pile in a way that does not damage or interfere with the existing condition of the pile.

The adjustable mounting device may have any suitable alternative form to that illustrated and may be made from any suitable material or materials, which may be resiliently deformable, for example in the manner of a rubber material, or resiliently deflectable, for example in the manner of a metal leaf spring, or resiliently compressible, for example in the manner of a plastic or metal coil spring.

It is to be understood that, depending on the form of the support, a pile-contacting portion thereof may be joined to the inner walling of the pile or may be abutted against the inner walling of the pile, in some examples being resiliently biased into contact with the pile.

In an example, the support 304 is configured to resiliently bias the at least one sensor 303 into contact with, or into an operational position with respect to, the inner walling 603 of the pile 601. The support may utilise one or more biasing elements, for example springs, to provide this functionality.

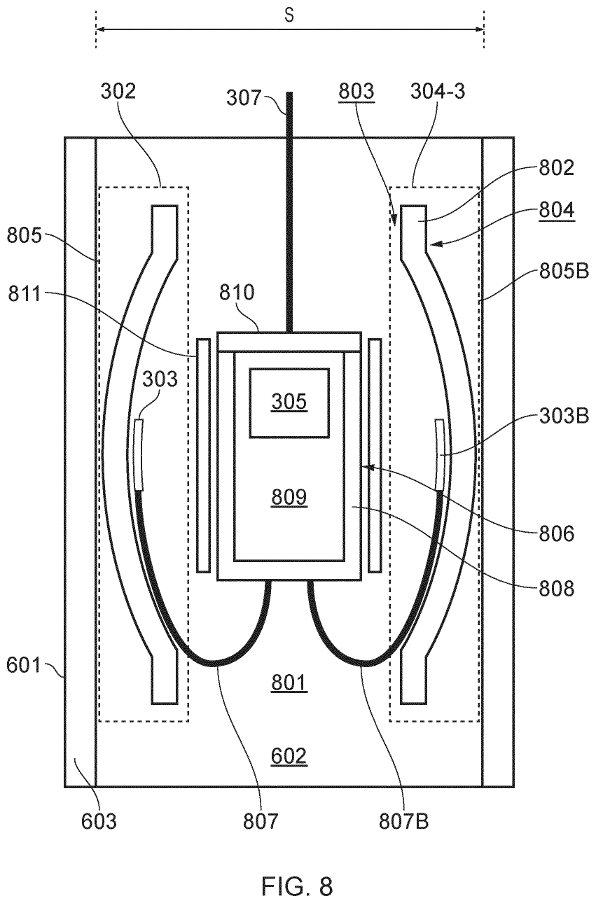

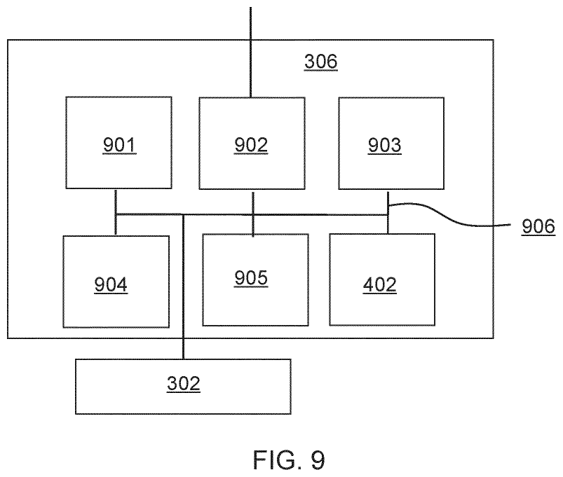

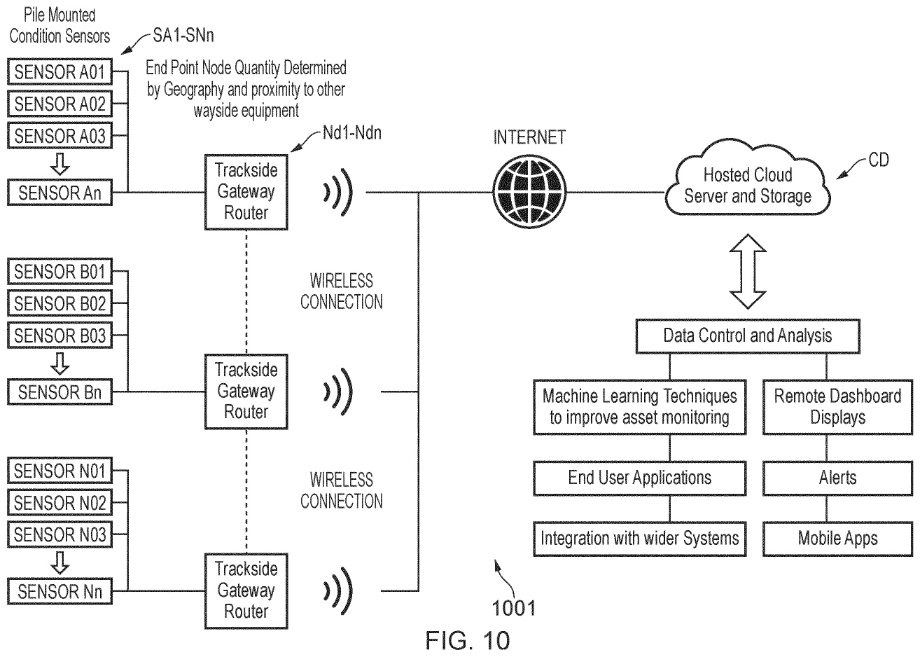

According to a specific example, illustrated in FIG. 8, a support 304-3 generally defines an interior region 801 and comprises walling 802, forming inner walling 803 and outer walling 804, in which at least a portion 805, 805B of the walling 802, extending between the inner walling 803 and the outer walling 804, is resiliently deflectable. The at least one sensor 303, 303B is held in contact with the walling 802 in a region of a resiliently deflectable portion 805, 805B, for sensing movement arising from a mechanical force applied to the respective resiliently deflectable portion 805, 805B of the walling 802, which, in use, will be experienced when a force is applied to the inner walling 603 of the pile 601. In use, the outer walling 804 of the resiliently deflectable portions 805, 805B are resiliently biased into contact with the inner walling 603 of the pile 601, with movement of the resiliently deflectable portions 805, 805B under the application of a mechanical force to the pile 601 that causes movement of the inner walling 603 of the pile 601 causing detectable changes in the sensors 303, 303B.

In this example, the sensing arrangement 302 comprises a housing 806 in which the signal conditioning electronics 305 are contained. Preferably, and in this example, the housing 806 is sealed to protect against the ingress of pollutants, such as particles and fluids, As indicated, each of the sensors 303, 303B is connected to the signal conditioning electronics 305 by means of a respective wired connection 807, 807B. The signal conditioning electronics 305 outputs signals to the controller 306 (not shown in this Figure, see FIG. 4) via communication connection 307 and respective individual terminal blocks 401, 401B (not shown in this Figure, see FIG. 4). The housing 806 is supported by the support 304-3.

In this example, housing 806 comprises a main body 808, which defines an interior 809, and at least one end closure element, such as end cap 810, that is releasably secured to the main body 808 and allows the interior 809 to be selectively accessed. End cap 810 may be detachably secured to the main body 808 by any suitable arrangement, for example a snap-fit arrangement or a screw thread arrangement.

The sensors 303, 303B of this illustrated example are strain gauge elements that are fixed to respective resiliently deflectable portions 805, 805B of the support 304-3. In use, the force sensors 303, 303B are responsive to movement of the respective resiliently deflectable portion 805, 805B of the support 304-3 to which it is fixed.

According to this illustrated example, the strain gauge elements 303, 303B are permanently fixed to the support 304-3 by bonding. In an example, the strain gauge elements are shielded from damage by a cover, which may be of any suitable type, for example an elastomeric or hard cover.

According to this specific illustrated example, the strain gauge elements 303, 303B are fixed to the inner walling 803 of the support 304-3. The strain gauge elements 303, 303B are arranged relative to the support 304-3 so as not to come into contact with the inner walling 603 of the pile 601.

In an example, the resiliently deflectable portions 805, 805B of the support 304-3 are provided by a spring element that is compressible to move the support 304-3 from an extended condition into a retracted condition (to reduce the span S of the support 304-3).

A compressive force can be applied to the spring element to move the support 304-3 into, and to hold the support 304-3 in, the retracted condition. When in the retracted condition, the support 304-3 can be slid into the interior 602 of the hollow pile 601. When located inside the pile 601, the applied compressive force can be removed to allow the spring element to return the support 304-3 into an extended condition in which it is retained at an installation position within the interior 602 of the hollow pile 601. When the support 304-3 is in contact with the inner walling 603 of the pile 601, the force sensors 303, 303B are operable to detect force applied to the pile 601 that causes deformation of the inner walling 603 of the pile 601.

The spring element may have any suitable form and may be made from any suitable material or materials, which may be resiliently deformable, for example in the manner of a rubber material, or resiliently deflectable, for example in the manner of a metal leaf spring, or resiliently compressible, for example in the manner of a plastic or metal coil spring.

As illustrated, additional or alternative sensor or other componentry may be located within the interior 801, such as component 811 shown disposed between the housing 806 and the pile contacting portions 805, 805B of the support 304-3.

It is to be understood that a sensor is in an operation position with respect to the inner walling of a hollow pile when the sensor is functional to detect movement of the inner walling of the pile when in use. Depending on the type of sensor, and the way that it is supported, it may or may not be in contact with the pile when in use.

Thus, a force sensor is in an operational position with respect to the inner walling of the pile when it is able to detect movement of the inner walling of the pile in the form of deformation of the inner walling of the pile, such as when a force is applied to the pile that causes the inner walling of the pile to deform. A force sensor when in an operational position with respect to the inner walling of the pile can be in contact with the inner walling of the pile (so that it is in a “contacting operational position”) or not (so that it is in a “non-contacting operational position”).

A gyroscopic sensor is in an operational position with respect to the inner walling of the pile when it is able to detect movement of the pile in the form of a change in angular orientation, such as when a force is applied to the pile that causes the inner walling of the pile to move from a reference orientation.

It is to be understood that a sensor can be non-fixedly held in contact with the inner walling of a pile or with the inner walling of a resiliently deflectable portion of the support. By “non-fixedly” it is meant that the force sensor 303 is not connected to the inner walling but is instead supported in such a way that it abuts the inner walling, in specific examples by being resiliently biased into contact with the inner walling by at least one movable engagement member of the support.

In use, the or each sensor is operable to detect movement of the pile.

As mentioned previously, in a specific example the sensing arrangement comprises at least one force sensor 303 that is a strain gauge comprising a convoluted electrically conductive trace. When the strain gauge 303 is in an operational position with respect to the inner walling 603 of the interior 602 of the pile 601, radial deformation of the pile 601, as may be expected to occur in consequence of compressive, i.e., radially inward, forces applied to the pile 601, will correspondingly deform the strain gauge 303, by stretching or compressing the conductive trace of the strain gauge 303. The electrical resistance of the conductive trace of the strain gauge may thereby be varied by compressive force applied to the inner walling 603 of the pile 601, and by comprising a measurement of the electrical resistance of the strain gauge 303 to a reference unloaded value, the compressive force exerted on the pile 601 may be measured, from which a deformation of the pile 601 can be inferred.

Thus, in summary, with the force sensor 303 being located within the interior 602 of the pile 601 and in an operational position with respect to the inner walling 603 of the pile 601 (in specific examples, being non-fixedly held in contact with the inner walling 603 of the pile 601 or being fixedly held in contact with a deflectable region 805 of the support 304-3 that in turn in non-fixedly held in contact with the inner walling 603 of the pile 601), a force applied to the pile 603 that deforms the inner walling 603 of the pile 601 causes an associated detectable change in the force sensor 303. The force sensor 303 can be received inside the pile 601 in such a manner that it is physically protected against deterioration arising from exposure to potentially harmful matter as, for example, water, debris, and pollutants, which serves to provide for repeatable, accurate data to be obtained.

A resiliently deflectable portion of the support, which should be sufficiently resiliently compressible to allow the at least one sensor to function as intended but sufficiently rigid to prevent excessive deformation in use and maintain structural integrity, and to protect components within its interior, may be made using any suitable material or materials and any suitable manner of construction.

As mentioned previously, in a specific example, and in this illustrated example, the sensor arrangement comprises a gyroscope sensor 314, for measuring angular deviation from a reference line. In an example, the gyroscope sensor 314 is utilised to measure degrees of angle with respect to a reference vertical line, extending in the axial direction of the pile, which measurements can beneficially be used in assessing the orientation of the pile. In an example, the gyroscope sensor is a multi-axis gyroscope sensor. In a specific example, the gyroscopic sensor is a 6-axis gyroscope sensor.

Referring next to FIG. 9, in a specific example, the controller 306 comprises central processing unit 901, memory 902, transceiver 903, input/output interface 904, power interface 905 and compass device 402.

Central processing unit 901 is configured for execution of commands, for processing of sensor data received from the sensing arrangement 302, and for overall control of the other hardware of the controller, including transceiver 903. Memory 902 is configured as read/write memory for non-volatile storage of sensor data received from the sensing arrangement 302. Transceiver 903 is provided for communication with a remote computer device, via communication module 311 (not shown in this Figure) and a wireless telecommunications network. The input/output interface 904 is operable for upload and download of data from memory 902, and may also allow the connection of peripheral devices to the controller 306.

Power interface 905 is provided for supplying electrical power to electrical consumers of the controller 306, such as the central processing unit 901 and the transceiver 903, and for supplying electrical power to the sensing arrangement 302. The power interface 905 may receive power from a battery resource and/or mains power.

Components (including components 901-905 and 402) of the controller 306 are in communication via system bus 906. A system bus controller may be provided as a separate module or be integrated with the controller 306.

Data obtained using the sensor assembly 301 may be transferred to a remote device in real-time, or at set intervals and/or on the occurrence of a predetermined event, or on demand.

The sensor assembly 301 may be utilised within a system, such as an Internet of Things (loT) system, to be monitored on-site and/or remotely via a web-based application, a desktop application, or a mobile application.

FIG. 10 shows an example sensor assembly network 901 that comprises a plurality of in-pile sensor assemblies SAₗ-SNₙ and a plurality of nodes Ndₗ-Ndₙ. Nodes Ndₗ-Ndₙ may be connected in a mesh network to provide more than one connection path for data transfer to the remote device CD. This is advantageous in situations in which direct communication between the controller associated with each sensor assembly SAₗ-SNₙ. and a remote device CD is impeded, for example by environmental or infrastructure obstacles or interference. The nodes are functional to aggregate data collected from the sensors via a wired connection, with the number of sensors that are connected to a single node being determined by, for example, such factors as geography and the distribution of piles. The nodes may be utilised in edge computing, to process data derived from the sensors to generate processed data for transfer from the controllers to the remote device CD. This is advantageous for mitigating the risk of network congestion and/or interruption.

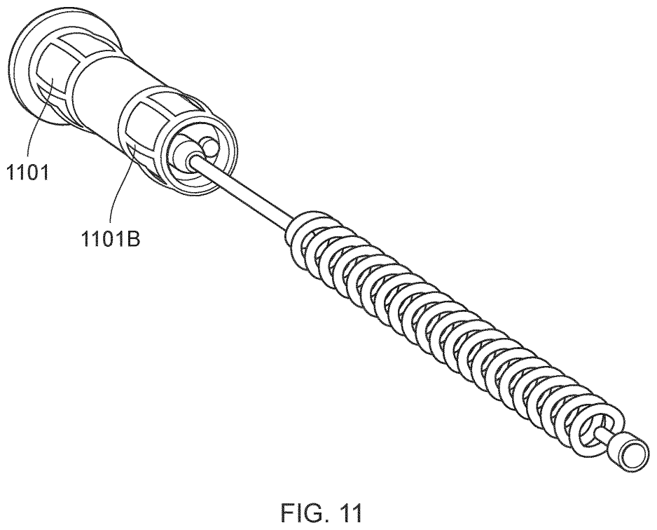

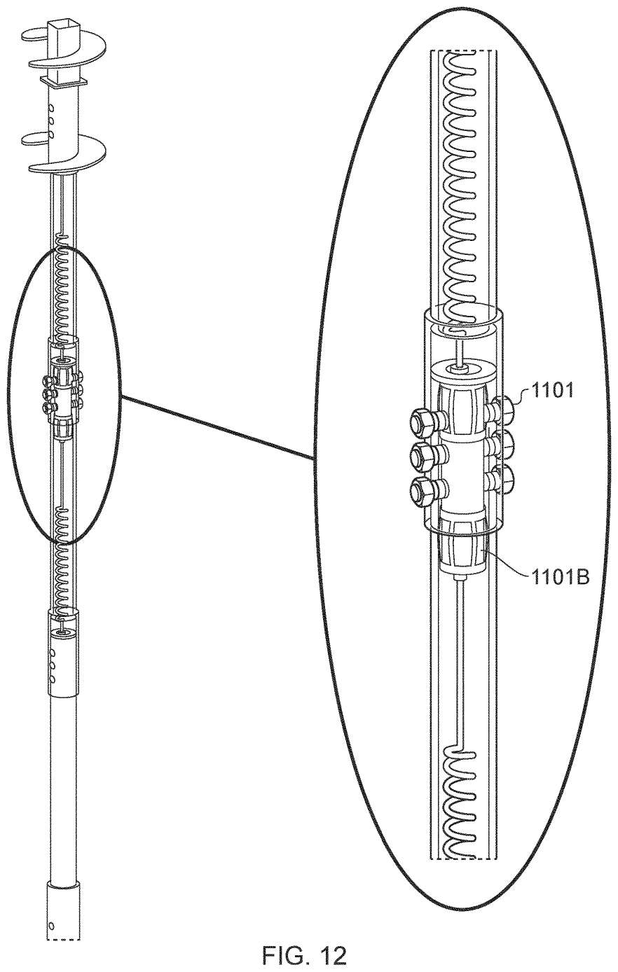

Referring now to FIGS. 11 & 12, as illustrated, a sensor package 309 of the sensor assembly 301 may be provided with at least one centralising element, such as centralising elements 1101, 1101B, for centralising the sensor package 309 within a hollow of a pile for use.

The present invention provides a sensor package for use in a sensor assembly for sensing movement of a pile. The sensor package comprises a sensing arrangement comprising at least one sensor, and a support to carry the sensing arrangement. The support is securable within a hollow of a pile to locate the sensing arrangement within the pile and position the at least one sensor of the sensing arrangement in an operational position with respect to an inner walling of the hollow of the pile for detecting movement of the inner walling of the pile. The sensor assembly comprises a controller for controlling the sensing arrangement. The controller may be located remotely of the sensor package and communicatively connected to the sensing arrangement thereof by a cabling arrangement that enables the transfer of power to the sensing arrangement and the transfer of data to the controller.

The sensing arrangement may comprise at least one force sensor for measuring load on the pile and/or at least one gyroscopic sensor for measuring angular deviation from a reference line.

The present invention further provides, in combination, a pile and the sensor assembly.

The present invention also provides a sensor system that comprises the sensor assembly, in which a communication module enabling wireless communication with a remote device is communicatively connected the controller, and a remote device configured to receive data from the controller, the data derived from operation of the sensor assembly.

The present invention further provides, in combination, a pile and the sensor system.

The present invention further provides a method, comprising the steps of: receiving the sensor assembly, securing the support of the received sensor assembly within a hollow of a pile to locate the sensing arrangement within the pile and position the at least one sensor of the sensing arrangement in an operational position with respect to an inner walling of the hollow of the pile for detecting movement on the inner walling of the pile, and operating the sensor assembly to sense a load on the pile.

As described, it is known for piles to be driven into the harder subgrade material to support track stability. Such piles generally have the form of a hollow tube and vary in length and diameter. The present invention provides a sensor system for use with such piles. The sensor system comprises one or more sensor packages, designed to be retro-fitted internally within the pile and in some cases as a first fix. The at least one sensor package and a surface telemetry box can be joined by a cable assembly that provides for data transfer and charging. The cable assembly can provide for data transfer, direct power and charging of an additional power source.

A sensor package may be fixed inside a pile in any suitable way, with possible fixing methods including welding, adhesion/bonding, or a mechanical arrangement, which may comprise an adjustable mounting device. A sensor package may be secured in position within a pile using an expanding calliper type device, for example having the illustrated 3-legged structure. The sensor package may be resiliently biased into contact with inner walling of the hollow of the pile. As also illustrated, a sensor package may alternatively be secured position within a pile by being fixed to the inner walling of the hollow of the pile.

The positioning and/or mode of siting a sensor package within the pile may be determined with Reference to such factors as pile type, pile dimensions, the depth that the pile has been driven to and the position of the pile within the track.

The sensor package may comprise at least one strain gauge but more preferably comprises two strain gauges for measuring strain and forces in the X, Y and Z axes, and may further comprise at least one gyroscope sensor but more preferably comprises multiple gyroscope sensors arranged to allow them to monitor a range of movement within the structure where the movement is generated by the displacement of the ground; however, the invention is not limited to this, for example, rail carriage vibrations may also be considered and monitored. The sensor package preferably comprises two or more strain gauges for measuring strain and forces in any combination of X, Y and Z axes.

The strain gauge may comprise a convoluted electrically conductive trace. The strain gauge may be sited within the pile in any suitable manner that allows movements to deform the strain gauge, by stretching or compressing the conductive trace.

The sensor package may be configured for wireless and/or wired data transmission. Wireless communication may be via any suitable protocol, for example via Bluetooth, WiFi or GPRS (General Packet Radio Services). Wireless communication may be via GSM (global system for mobile communications), The sensor package may further comprise a memory resource for data storage, and hence back up monitoring can be enabled.

The sensor package may be powered in any suitable way, for example directly from mains or via batteries, a capacitor bank, or using solar power.

In a specific example, the sensor package will have a cable arrangement for data and power, and this will be connected to a surface telemetry box, which offers data storage and data transmission via wired communication and/or any suitable wireless communication protocol. The box may be manufactured from any suitable material or materials, including, but not limited to, synthetic materials, metals, and injection moulded materials.

Data collected from the or each sensor package will be collected, aggregated, and transmitted to a central platform, which may be comprised by an Internet of Things (IoT) system. The system may allow data to be collected via a wireless connection and/or a wired connection. Data may be stored for accessing at a later time and/or be accessed in real time.

Although illustrative embodiments and examples of the invention have been disclosed in detail herein, with reference to the accompanying drawings, it is to be understood that the invention is not limited to the precise embodiment and examples shown and/or described and that various changes and modifications can be effected therein by one skilled in the art without departing from the scope of the invention as defined by the appended claims.

1. A sensor assembly for sensing movement of a pile, the sensor assembly comprising:
a sensing arrangement comprising at least one sensor, and
a support to carry the sensing arrangement;
the support securable within a hollow of the pile to locate the sensing arrangement within the pile and position the at least one sensor of the sensing arrangement in an operational position with respect to an inner walling of the hollow of the pile for detecting movement of the inner walling of the pile, and
a controller for controlling the sensing arrangement.

2. The sensor assembly of claim 1, wherein the at least sensor comprises at least one force sensor for detecting load.

3. The sensor assembly of claim 2, wherein the or each force sensor is a strain gauge.

4. The sensor assembly of claim 3, wherein the force sensor or plurality of force sensors is configured to measure strain in 3 axes.

5. The sensor assembly of claim 1, wherein the at least sensor comprises at least one gyroscopic sensor for measuring angular deviation from a reference line.

6. The sensor assembly of claim 6, wherein the gyroscopic sensor is a multi-axis gyroscope sensor.

7. The sensor assembly of claim 1, wherein the support comprises a fixing element attachable to the inner walling of the pile.

8. The sensor assembly of claim 1, wherein the support comprises an adjustable mounting device configurable between an extended and a retracted condition, in which a span of the adjustable mounting device is greater when in the extended condition than when in the retracted position, the retracted condition for allowing insertion of the support into the hollow of the pile and the extended condition allowing for retaining the support within the pile.

9. The sensor assembly of claim 8, wherein the adjustable mounting device is resiliently biased towards the extended condition.

10. The sensor assembly of claim 1, wherein the support is configured for resiliently biasing at least one sensor into contact with the inner walling of the pile.

11. The sensor assembly of claim 1, wherein the support comprises walling, at least a portion of which is a resiliently deflectable portion, in which at least one sensor is held in contact with the walling in a region of a resiliently deflectable portion and the support is configured for resiliently biasing the resiliently deflectable portion into contact with the inner walling of the pile.

12. The sensor assembly of claim 1, wherein the controller is operatively connected to the sensing arrangement by a communication connection enabling the transfer of data between the controller and the sensing arrangement.

13. The sensor assembly of claim 12, wherein the controller is configured to receive power from a power source and the communication connection enables the transfer of power to the sensing arrangement.

14. The sensor assembly of claim 1, wherein a communication module enabling wireless communication with a remote device is communicatively connected the controller.

15. The sensor assembly of claim 1, the controller comprising a compass device and is functional to calibrate the sensor device or sensor devices connected to it in relation to a predetermined direction.

16.-19. (canceled)

20. A sensor system, comprising:
a sensor assembly as claimed in claim 14, and a remote device configured to receive data from the controller, the data derived from operation of the sensor assembly.

21. (canceled)

22. A method, comprising the steps of:
receiving a sensor assembly as claimed in claim 1,
securing the support of the received sensor assembly within a hollow of a pile to locate the sensing arrangement within the pile and position the at least one sensor of the sensing arrangement in an operational position with respect to an inner walling of the hollow of the pile for detecting movement of the inner walling of the pile, and
operating the sensor assembly to detect movement of the pile.

23. The sensor assembly of claim 8, wherein the support is configured for resiliently biasing at least one sensor into contact with the inner walling of the pile.

24. The sensor assembly of claim 8, wherein the support comprises walling, at least a portion of which is a resiliently deflectable portion, in which at least one sensor is held in contact with the walling in a region of a resiliently deflectable portion and the support is configured for resiliently biasing the resiliently deflectable portion into contact with the inner walling of the pile.

25. The sensor assembly of claim 9, wherein the support comprises walling, at least a portion of which is a resiliently deflectable portion, in which at least one sensor is held in contact with the walling in a region of a resiliently deflectable portion and the support is configured for resiliently biasing the resiliently deflectable portion into contact with the inner walling of the pile.
